(19) United States
(12) Patent Application Publication
(10) Pub. No.: US 2017/0011477 A1
(43) Pub. Date: Jan. 12, 2017

(54) MARKETING REAL ESTATE USING COMPOSITED AERIAL PHOTOGRAPH AND FLOOR PLAN

(71) Applicant: Ryan Murphey, San Clemente, CA (US)

(72) Inventor: Ryan Murphey, San Clemente, CA (US)

(21) Appl. No.: 15/271,640

(22) Filed: Sep. 21, 2016

(51) Int. Cl. G06Q 50/16; G06Q 40/02

(52) U.S. Cl. CPC G06Q 50/16; G06Q 40/025

(57) ABSTRACT

A method of marketing real estate is disclosed for real estate that contains a structure having an outer perimeter, rooms within the outer perimeter, and an environment surrounding the structure. The method may include: obtaining an aerial photograph of the real estate that includes the structure and the environment surrounding the structure; obtaining a floor plan of the structure that has an outer perimeter; creating a composite image of the aerial photograph and the floor plan by superimposing the floor plan on the aerial photograph such that the outer perimeter of the floor plan and the outer perimeter of the structure substantially overlap; and making the composite image available to one or more persons interested in purchasing or leasing the real estate.

### TECHNICAL FIELD

This disclosure relates to methods of marketing real estate, aerial photographs, and floor plans.

### DESCRIPTION OF RELATED ART

Persons interested in purchasing or leasing real estate often look at various types of information when deciding whether to visit the real estate or to look into it further.

These presentations commonly include interior and exterior photographs. In some cases, videos and/or 360 degree virtual tours may also be provided.

All of these presentations, however, can leave interested persons without a strong sense of where each room is with respect to other rooms and the surrounding environment. Videos and 360 degree presentations, moreover, may require a high Internet bandwidth connection that may not be available. These problems can lead to an interested person overlooking a property that is truly of interest or going to view a property that is not truly of interest.

### SUMMARY

A method of marketing real estate is disclosed for real estate that contains a structure having an outer perimeter, rooms within the outer perimeter, and an environment surrounding the structure. The method may include: obtaining an aerial photograph of the real estate that includes the structure and the environment surrounding the structure; obtaining a floor plan of the structure that has an outer perimeter; creating a composite image of the aerial photograph and the floor plan by superimposing the floor plan on the aerial photograph such that the outer perimeter of the floor plan and the outer perimeter of the structure substantially overlap; and making the composite image available to one or more persons interested in purchasing or leasing the real estate.

The obtaining the aerial photograph may include taking the aerial photograph with a drone or a satellite.

The floor plan may include measurements of the rooms.

The real estate may be a lot having a lot size. The method may include adding the lot size to the composite image.

The real estate may have a swimming pool with a depth. The method may include adding information about the depth of the swimming pool to the composite image.

The swimming pool may have a deep and a shallow portion. The method may include adding information about the depth of both the deep and shallow portion to the composite image.

The creating the composite image of the aerial photograph and the floor plan may include adjusting the size of the floor plan or the aerial photograph so that the outer perimeter of the floor plan and the outer perimeter of the structure substantially overlap.

The making the composite image available to one or more persons may include posting the composite image on the Internet.

The method may include taking photographs of the rooms and making the photographs available to the one or more persons along with the composite image.

A composite image may include: an aerial photograph of real estate containing a structure having an outer perimeter, rooms within the outer perimeter, and an environment surrounding the structure; and a floor plan of the structure that has an outer perimeter on top of the aerial photograph. The outer perimeter of the floor plan and the outer perimeter of the structure substantially overlap.

The composite image may include measurements of the rooms.

The real estate may be a lot having a lot size. The composite image may include the lot size.

The real estate may have a swimming pool with a depth. The composite image may include information about the depth of the swimming pool.

The swimming pool may have a deep and a shallow portion. The composite image may include information about the depth of both the deep and shallow portion.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates a flow diagram of an example process for marketing real estate using a composited aerial photograph and a floor plan.

FIG. 2 illustrates an example of an aerial photograph of real estate containing a structure having an outer perimeter, rooms within the outer perimeter, and an environment surrounding the structure.

FIGS. 3-9 each illustrate an example of a photograph of a room within the structure, as well as a textual description identifying the room.

FIG. 10 illustrates an example of a photograph of another near-by structure, such as a swimming pool, as well as a textual description identifying the structure.

FIG. 11 illustrates an example of a floor plan of the structure.

FIG. 12 illustrates an example of a composite image of the floor plan illustrated in FIG. 11 superimposed on the aerial photograph illustrated in FIG. 2 in which the outer perimeter of the floor plan and the outer perimeter of the structure substantially overlap.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

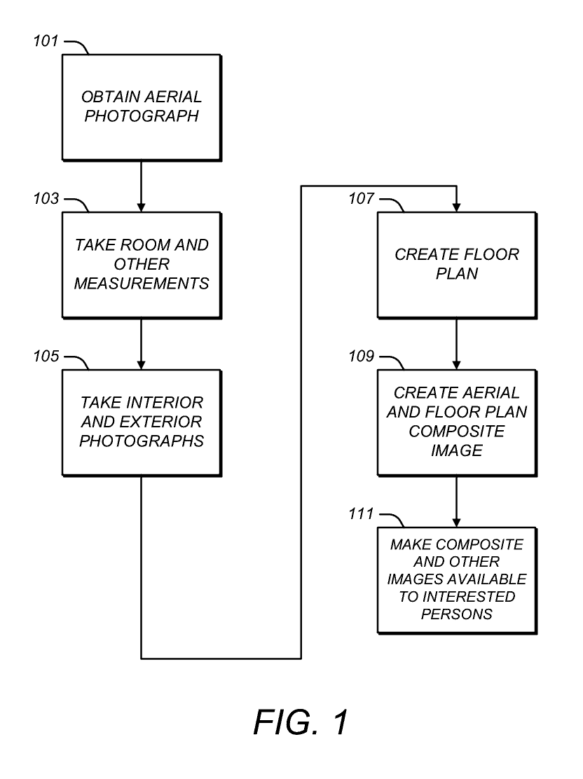

FIG. 1 illustrates a flow diagram of an example process for marketing real estate using a com posited aerial photograph and a floor plan.

The process may include obtaining an aerial photograph of the real estate, as illustrated in an Obtain Aerial Photograph step 101 in FIG. 1.

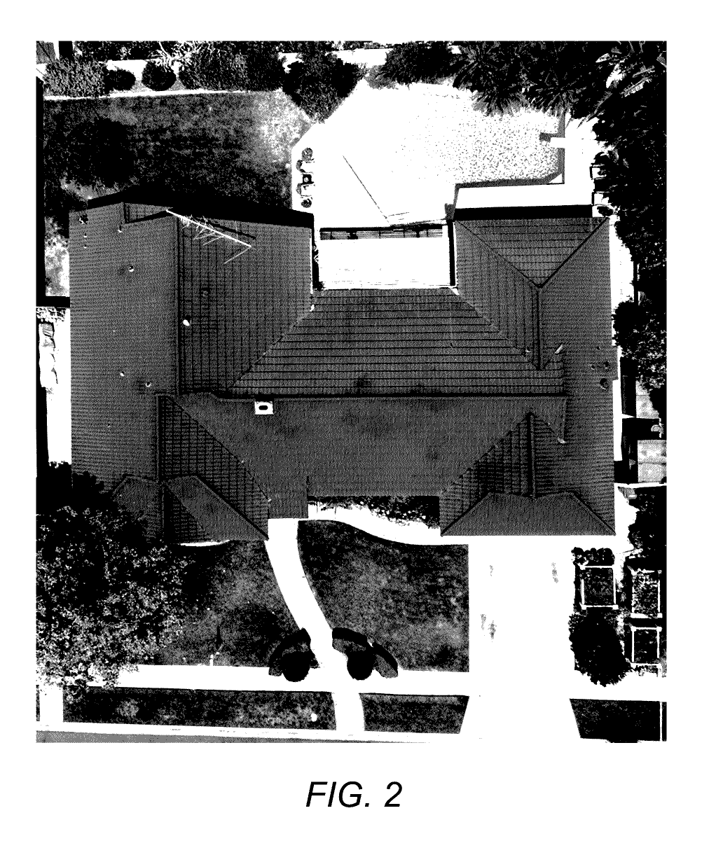

FIG. 2 illustrates an example of an aerial photograph of real estate containing a structure 201 having an outer perimeter 203, rooms within the outer perimeter, and an environment surrounding the structure. The environment may include surrounding landscaping such as fruit trees, sidewalks, a swimming pool, a BBQ or fire pit, a sports court, fruit trees, and/or any other type of structure or decoration. The environment may or may not include portions of adjoining properties. One or more features in the photograph may be highlighted in some way, such as a new A/C unit and/or solar panels.

The aerial photograph may be obtained by any means.

For example, the aerial photograph may be obtained from a satellite picture, such as a satellite picture displayed on Google maps. The portion of such an image that contains the desired real estate may be cropped from the larger image and enlarged. A license to use the aerial photograph may also be obtained.

A drone may instead be used to capture the aerial photograph. When this is done, local FAA altitude limits may be checked. A walk around the real estate may be done to identify trees, powerlines, and any other abstraction that might get in the way and therefore might need to be avoided.

The drone may be prepped for takeoff. The drone may be placed on a flat unobstructed surface, such as a 10′×10′ square. An effort may be made to make sure that a GPS home point in the drone is updated and that its compass is calibrated. A come-home function in the drone may be activated and the drone may be set to return home without exceeding the local FAA altitude limit. Both the drone and its controller may have at least 50% of their respective batteries left.

Before takeoff, a second person (spotter) may look over the area again to spot any obstacles that may have been missed. The propellers may be checked to insure that they are tight. The drone may then be directed to take off.

The drone may then be controlled to hover approximately centered above the structure. The hovering height may be of any amount, such as within 5-20 meters over the roof of the structure. An effort may also be made to make sure that the drone does not go over maximum FAA altitude restrictions.

Care may be taken to insure that the photograph to be taken includes the entire structure and the environment surrounding it, such as surrounding trees such as fruit trees, bushes, sidewalks, pools, BBQ or fire pit, and sports courts. The image may or may not also include portions of neighboring structures. The frame of the photograph may then be adjusted to the needed size by changing the hover height of the drone and/or by changing the zoom of the drone camera.

The photograph may then be taken and the drone may then be directed to return to its starting point or to a different location. The image that is captured by the drone may then be cropped or otherwise edited as needed to insure that it does not include portions that are not of interest.

A hand drawn sketch may instead me made and used for all or portions of the structure and surrounding environment.

As reflected in a Take Room and Other Measurements step 103 in FIG. 1, measurements of some or all of the rooms in the structure may then be taken. This may include closets, bathrooms, and a garage. Measurements of the lot on which the structure resides may also be taken, along with measurements of adjoining structures, such as an adjoining swimming pool. When a swimming pool is present, measurements of its deepest and shallowest depth may also be made.

The measurement step 103 may precede step 101, come later in the process, or be done at both times with respected to different portions of the real estate. The measurements may be taken in any way, such as by using a laser and/or tape measure.

The square footage of each room, the total lot, the lot both in front and in back of the structure, and other aspects of the real estate may also be calculated and recorded.

As reflected in a Take Interior and Exterior Photographs step 105, pictures may then individually be taken of some or all of the interior rooms, the exterior of the home from the front, back, side, and/or other directions, and/or other aspects of the real estate.

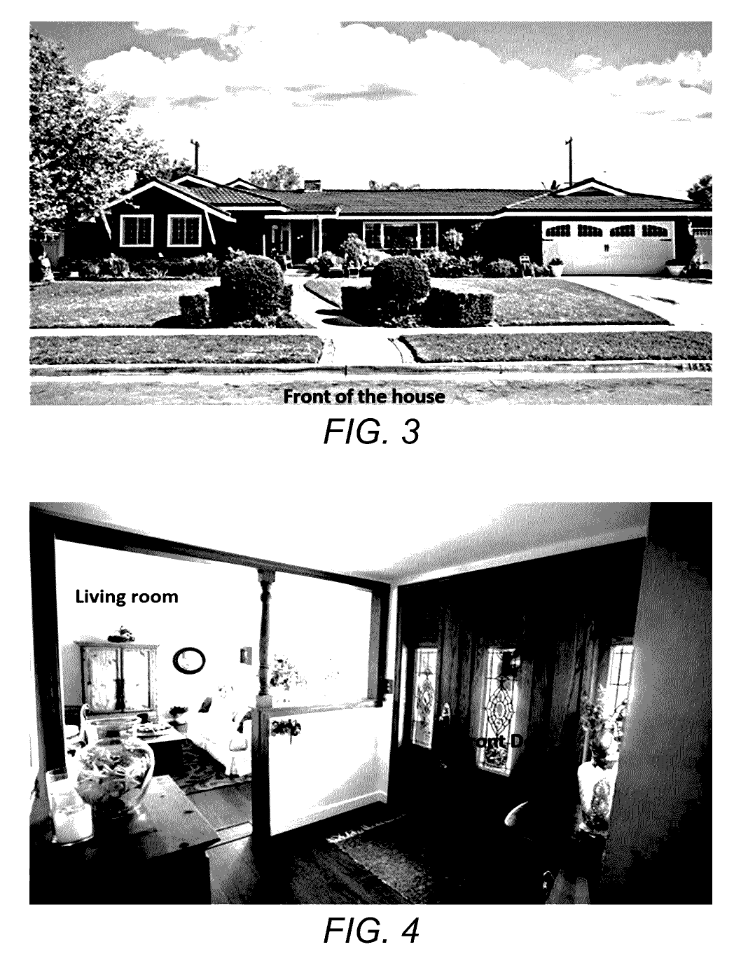

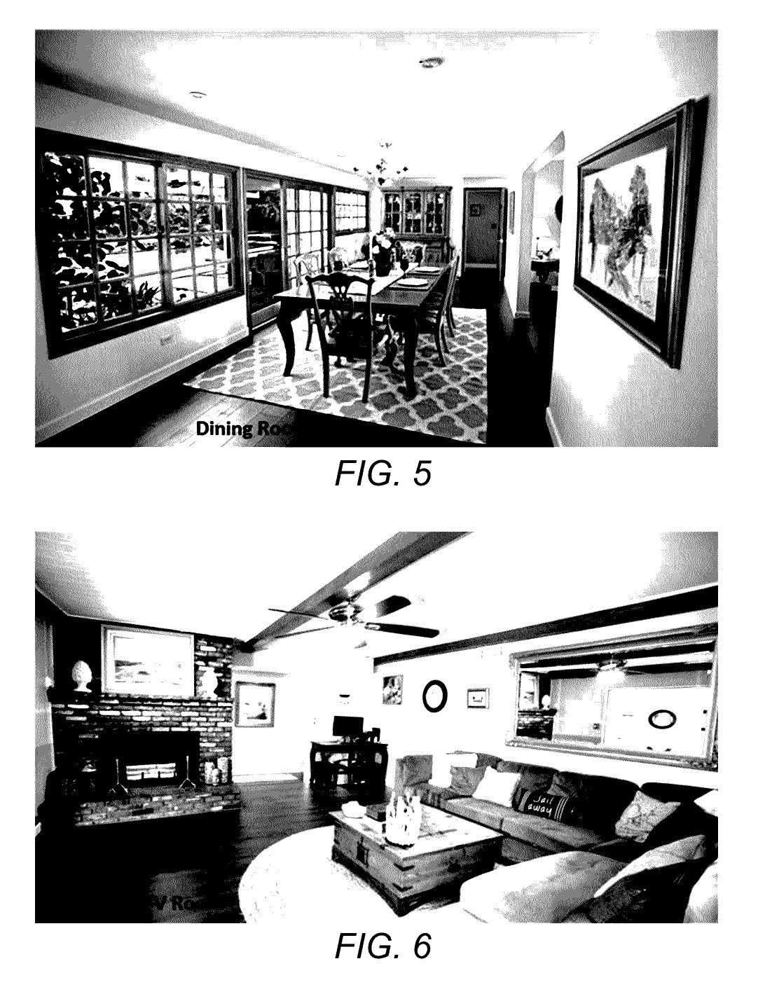

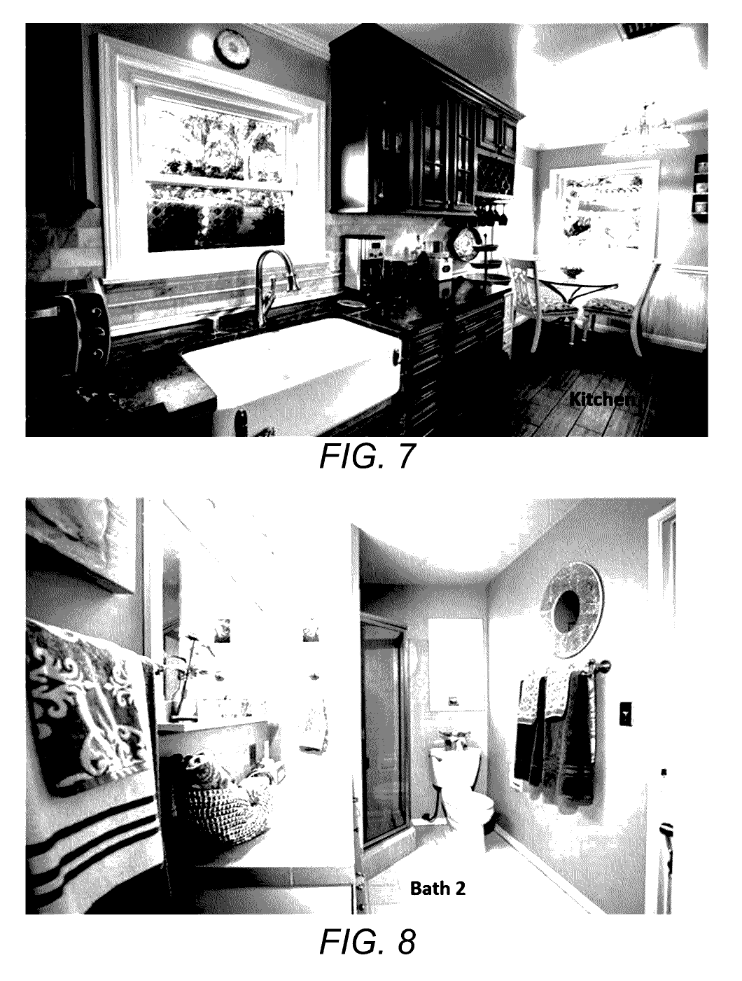

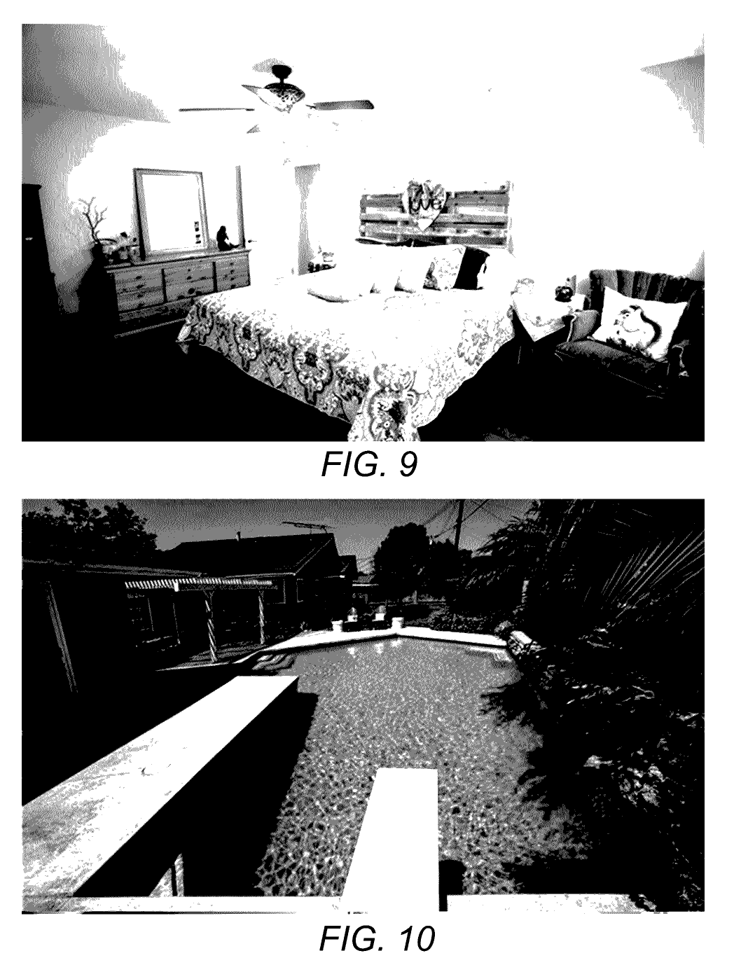

FIGS. 3-9 each illustrate an example of a photograph of a room within the structure that has been taken, as well as a textual description identifying the room. The textual description may be added after each photograph is taken.

FIG. 10 illustrates an example of a photograph of another near-by structure, such as a swimming pool, as well as a textual description identifying the structure. This photograph may be taken at the same time as the photographs illustrated in FIGS. 3-9 or at a different time.

As reflected in a Create Floor Plan step 107, a floor plan may then be created.

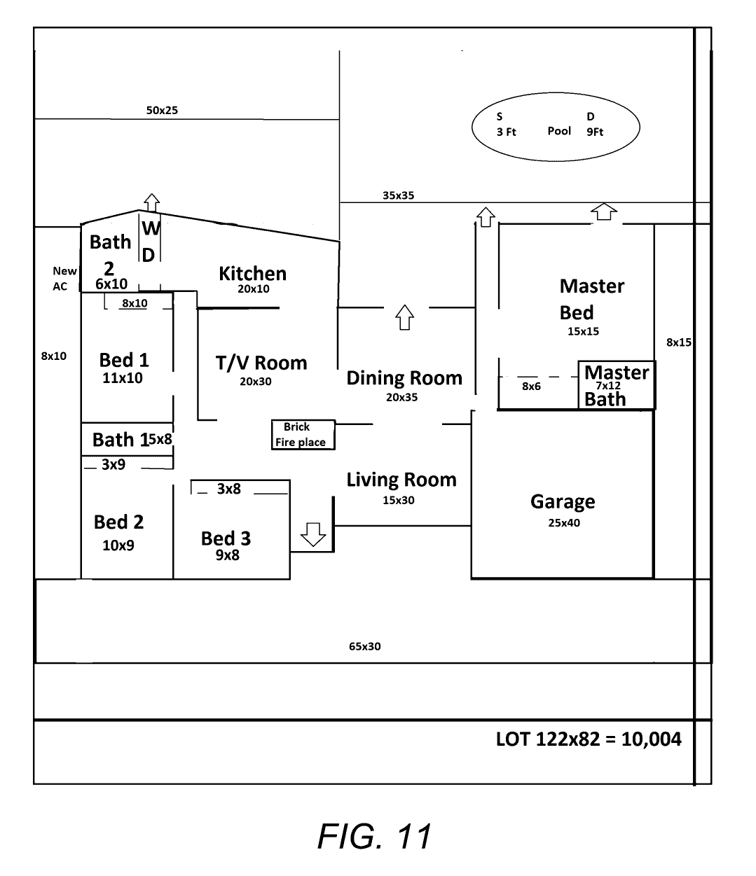

FIG. 11 illustrates an example of a floor plan of the structure. As illustrated in FIG. 11, the floor plan may include the perimeter of each room within the structure, the name of each room, and the dimensions of each room. It may also include the square footage of each room and/or the total square footage. The photographs that may have been taken may be used to help in the creation of this floor plan.

A composite image may then be created of the aerial photograph and of the floor plan by superimposing the floor plan on the aerial photograph such that the outer perimeter of the floor plan and the outer perimeter of the structure substantially overlap. This may require adjusting the image size of the floor plan and/or the aerial photograph so that the outer perimeter of the floor plan and the outer perimeter of the structure substantially overlap.

The use of the phrase “substantially overlap” is intended to make allowances for instances with the overlap is not perfect, but very close, e.g., within a few inches. This can occur because of minor errors in the floor plan, minor differences in the relative sizes of the aerial photograph and the floor plan, and/or minor perimeter alignment errors.

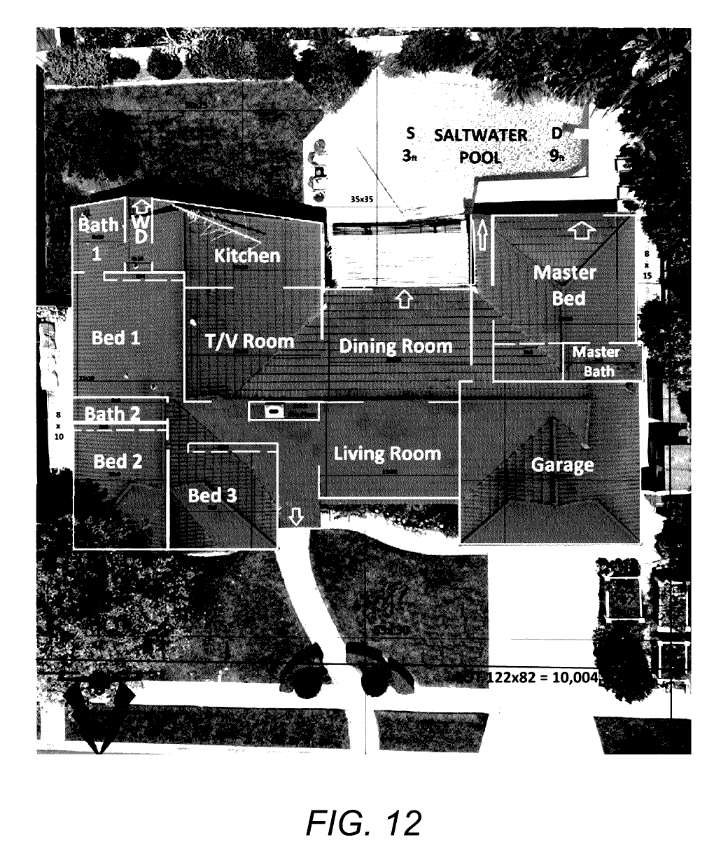

FIG. 12 illustrates an example of a composite image of the floor plan illustrated in FIG. 11 superimposed on the aerial photograph illustrated in FIG. 2 in which the outer perimeter of the floor plan and the outer perimeter of the structure substantially overlap. As illustrated in FIG. 12, additional information may be added to the composite image, such as the depth of the deepest and shallowest portions of an adjoining swimming pool, the dimensions of the lot, and/or square footage information. The composite image may highlight in some manner improvements or features of special interest, such as a new A/C unit, solar panels, built in BBQ, fire pit, sports courts, and/or an indication of fruit trees and their types.

The composite image and optionally one or more of the ground photographs may then be made available to person(s) interested in purchasing and/or leasing the real estate, as reflected in a Make Composite and Other Images Available to Interested Persons step 111. This may be done, for example, by physically delivering prints of these to the interested person(s) and/or by posting the composite image and optionally ground photographs on the Internet and/or by delivering them to a software application running in a mobile device or on a desktop computer in a manner that will allow them to be accessed by the interested person(s), either with or without password or other access restrictions.

The components, steps, features, objects, benefits, and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits, and/or advantages. These also include embodiments in which the components and/or steps are arranged and/or ordered differently.

For example, the floor plan may include: multiple levels, each of which may be separately superimposed on a different copy of the aerial photograph. The floor plan may also depict detached structures, like a pool house or guest home. The aerial photograph may also be of vacant land on which a structure may be built, in which case the proposed structure, environment, and floor plan may all be superimposed on the aerial photograph. The depicted structure may also only be a portion of a structure. Multiple lots might also be depicted, such as multiple parking lots or structures, indoor or outdoor sporting fields, or structures like a little league park which might have several fields that can be labeled for tournaments, bathrooms, and snack bars. The structure may be a home, a school, a church, or any other type of structure. Retail, commercial (shopping centers) and amusement parks may also be included. Paths and trails, such as hiking or bike paths may be depicted. Hotels and resorts ex ski resorts may be depicted. Street fairs with vendor cells may also be depicted. Anything that might need a real time photo with an overlaid description can be included or depicted to help someone have a clearer picture of what they are looking at.

The aerial photograph might instead be of a street fair, sports field, and/or a large entertainment venue containing multiple structures. A site plan might then be overlaid on top of it, such as site plan that labels each shop or restaurant and/or where each restroom is located.

The various methods and systems that have been described represent a significant improvement to the technology of image generation based on multiple different types of data and information.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases from a claim means that the claim is not intended to and should not be interpreted to be limited to these corresponding structures, materials, or acts, or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element proceeded by an “a” or an “an” does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended coverage of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

The invention claimed is:

1. A method of marketing real estate, the real estate containing a structure having an outer perimeter, rooms within the outer perimeter, and an environment surrounding the structure, the method comprising:
obtaining an aerial photograph of the real estate that includes the structure and the environment surrounding the structure;
obtaining a floor plan of the structure that has an outer perimeter;
creating a composite image of the aerial photograph and the floor plan by superimposing the floor plan on the aerial photograph such that the outer perimeter of the floor plan and the outer perimeter of the structure substantially overlap; and
making the composite image available to one or more persons interested in purchasing or leasing the real estate.

2. The method of claim 1 wherein the obtaining the aerial photograph includes taking the aerial photograph with a drone.

3. The method of claim 1 wherein the obtaining the aerial photograph includes obtaining an aerial photograph taken by a satellite.

4. The method of claim 1 wherein the floor plan includes measurements of the rooms.

5. The method of claim 1 wherein the real estate is a lot having a lot size and further comprising adding the lot size to the composite image.

6. The method of claim 1 wherein the real estate has a swimming pool with a depth and further comprising adding information about the depth of the swimming pool to the composite image.

7. The method of claim 6 wherein the swimming pool has a deep and a shallow portion and further comprising adding information about the depth of both the deep and shallow portion to the composite image.

8. The method of claim 1 wherein the creating the composite image of the aerial photograph and the floor plan includes adjusting the size of the floor plan or the aerial photograph so that the outer perimeter of the floor plan and the outer perimeter of the structure substantially overlap.

9. The method of claim 1 wherein the making the composite image available to one or more persons includes posting the composite image on the Internet or delivering the composite image to a software application running on a mobile device or desktop computer.

10. The method of claim 1 further comprising taking photographs of the rooms and making the photographs available to the one or more persons along with the composite image.

11. A composite image comprising:
an aerial photograph of real estate containing a structure having an outer perimeter, rooms within the outer perimeter, and an environment surrounding the structure; and
a floor plan of the structure that has an outer perimeter on top of the aerial photograph,
wherein the outer perimeter of the floor plan and the outer perimeter of the structure substantially overlap.

12. The composite image of claim 11 further comprising measurements of the rooms.

13. The composite image of claim 11 wherein the real estate is a lot having a lot size and wherein the composite image further comprises the lot size.

14. The composite image of claim 11 wherein the real estate has a swimming pool with a depth and wherein the composite image further comprises information about the depth of the swimming pool.

15. The composite image of claim 14 wherein the swimming pool has a deep and a shallow portion and wherein the composite image further comprises information about the depth of both the deep and shallow portion.
